(19) United States
(12) Patent Application Publication
(10) Pub. No.: US 2011/0130893 A1
(43) Pub. Date: Jun. 2, 2011

(54) ENERGY MANAGEMENT SYSTEM

(76) Inventors: David S. Gilleland, Charlotte, NC (US); Rob Satchwell Tennant, Matthews, NC (US); Michael Layton Gregory, Clover, SC (US); Pieter Erasmus, Boksburg North (ZA)

(21) Appl. No.: 12/889,549

(22) Filed: Sep. 24, 2010

Related U.S. Application Data
(63) Continuation-in-part of application No. PCT/US2009/005463, filed on Oct. 5, 2009.
(60) Provisional application No. 61/245,500, filed on Sep. 24, 2009.
(60) Provisional application No. 61/257,313, filed on Nov. 2, 2009.

(30) Foreign Application Priority Data
Aug. 4, 2010 (GB) GB1013127.4
Aug. 4, 2010 (GB) GB1013128.2
Aug. 4, 2010 (GB) GB1013129.0
Aug. 4, 2010 (GB) GB1013130.8
Aug. 4, 2010 (GB) GB1013131.6

(51) Int. Cl. G06F 7/00

(52) U.S. Cl. 701/2

(57) ABSTRACT

A vehicle power controller and a control method are described. The vehicle power controller is arranged to receive a remote command to set an inactivity time interval and to shut down a component of a vehicle, such as an engine, if it is inactive for the time interval.

### CROSS REFERENCES TO RELATED APPLICATIONS

This application is a continuation-in-part of International Application No. PCT/US2009/005463, filed Oct. 5, 2009, which claims the benefit of U.S. Provisional Application No. 61/245,500, filed Sep. 24, 2009, the entire disclosures of which are hereby incorporated by reference. This application also claims the benefit of U.S. Provisional Application No. 61/257,313, filed Nov. 2, 2009, the entire disclosure of which is hereby incorporated by reference.

This application also claims the benefit of the following applications: GB Application No. 1013129.0, filed August 4, 2010, GB Application No. 1013128.2, filed Aug. 4, 2010, GB Application No. 1013127.4, filed Aug. 4, 2010, GB Application No. 1013130.8, filed Aug. 4, 2010, and GB Application No. 1013131.6, filed Aug. 4, 2010, the entire disclosures of which are hereby incorporated by reference.

### BACKGROUND OF THE INVENTION

The present invention relates to materials handling vehicles and to efficiency improvements for vehicles which are of particular relevance for fleets of vehicles such as materials handling.

The problems of climate change are well known and it is considered desirable to reduce wasteful energy consumption and carbon dioxide emissions wherever possible. Whilst idling, vehicles consume energy unnecessarily and emit carbon dioxide. Thus, it has been proposed to detect vehicle idling and to switch off or shut down an idle vehicle after a set time. However, where circumstances require a vehicle to start and stop frequently a simple time-out may be impractical or unsafe. Moreover, the energy cost associated with repeatedly turning an engine on and off may reduce efficiency whilst the associated delays in operation may be unacceptable to a vehicle operator.

Where fleets of vehicles are operated efficiency gains or losses are cumulative across the fleet and may have significant environmental impacts. Therefore, in fleets of vehicles, such as materials handling vehicles energy efficiency is particularly desirable. Typically such vehicles operate in relatively confined spaces where more than one such vehicle may be present. Clearly, in a working environment in which multiple vehicles move about a limited space, shutting down a vehicle may have safety implications. For example switching off the engine of a vehicle whilst it is in the vicinity of other materials handling vehicles which are lifting and moving heavy loads is undesirable and may even be dangerous. The inventors in the present case have recognised a need to reduce the energy consumption and carbon footprint of fleets of materials handling vehicles without compromising their effectiveness or safety of operation.

Aspects and examples of the invention are set out in the claims and address at least a part of the above described problem.

The inventors in the present case have appreciated that in a fleet of vehicles operating in a facility the operational requirements of a vehicle vary according to its location in the facility, the time of day (for example as a result of operator shift patterns) or according to the tasks assigned to the vehicle's operator or other factors. Accordingly, in an aspect the invention provides a programmable vehicle power controller comprising a wireless communication interface, and a vehicle inactivity detector for detecting inactivity affecting a component of a vehicle and a shutdown controller coupled to shut down at least the component of the vehicle, wherein the shutdown controller is arranged to receive over the wireless communication interface a command to set an inactivity time interval based on the received command and to shut down the component following inactivity for the time interval. This has the advantage of enabling vehicles to shut down when idle if operational parameters indicate that it is appropriate to do so. By remotely configuring a timeout, vehicles can be reprogrammed either automatically or manually to optimise shutdown for a particular application.

Preferably the vehicle inactivity detector is coupled to a CANBUS of the vehicle to detect inactivity of a vehicle component. This has the advantage that inactivity of a vehicle component is detected without the need for direct coupling to the component.

In one possibility the shut down controller is configured to derive vehicle operator information from an authorisation control unit arranged to record an identifier of a vehicle operator, preferably wherein vehicle operator information is derived from a removable reprogrammable token adapted for use with the authorisation control unit, preferably wherein the vehicle power controller is configured to set the time interval based on a time of day and vehicle operator information. These possibilities have the advantage that a shut down controller can modify an inactivity time interval to suit a particular operator, for example to match a shift pattern.

For example the vehicle power controller can be coupled to communicate with a database storing an association between vehicle operator information and an indication of shift timings of the operator, wherein the programmable vehicle power controller is configured to determine a time of day and to select an inactivity time interval based on the shift timings of the operator and the time of day. This has the advantage that the inactivity time interval can be set to be longer during times that the operator is likely to need to stop and start a vehicle frequently, for example in the middle of his shift whilst at the start and end of a shift when the operator is more likely to be moving a vehicle into or out of a parking area, the inactivity time interval can be reduced to improve efficiency.

In one possibility, the operational parameter referred to above may comprise the location of the vehicle in the facility and/or the number of other vehicles operating in the vicinity of the vehicle. Employing such parameters (either singly or in combination) has the advantage of enabling the idle shut-down behaviour of a materials handling vehicle to adapt to operational need to improve energy efficiency without compromising effectiveness or safety. In one possibility a memory stores an association between one or more operational parameters and a permitted period of inactivity (an inactivity time delay) to enable the inactivity time period to be updated automatically without the need for a remote command.

Preferably the vehicle power controller is coupled to a position determiner configured to determine vehicle position information and to report vehicle position information to a remote device over the wireless communication interface. This has the advantage that vehicle position information can be used to determine an inactivity time interval.

A facility monitoring and control system comprises a server having a wireless communication interface for communication with a plurality of vehicle power controllers to receive vehicle information; a database storing at least one association between vehicle information and an inactivity time interval; and a processor coupled to the communication interface and configured to retrieve a time interval from the database based on received vehicle information and to transmit a command comprising the inactivity time interval over the communication interface to a remote device. This has the advantage that vehicles can be adaptively controlled to optimise their idling behaviour to improve energy efficiency without compromising operational requirements such as safety and effectiveness.

In one possibility the database stores an association between a plurality of vehicles and a single inactivity time interval and wherein the processor is configured to transmit a remote command comprising the single inactivity time interval to the plurality of vehicles. This has the advantage that the inactivity timeout behaviour of a group of vehicles can be modified together, for example automatically at a time of day such as at the beginning and/or end of a time period associated with use of those vehicles.

Examples of the invention modify an inactivity time interval based on a location measurement. In one possibility location measurement for mobile assets such as vehicles may be performed using GPS systems or cellular network mast triangulation (cell triangulation). In storage facilities and industrial complexes the communications environment does not always favour such methods, for example GPS satellite signals may obscured by structures between the GPS receiver and the satellite. Similarly, where triangulation methods are employed if one of the signals employed is obscured the accuracy of the technique may degrade. In addition, in enclosed facilities problems such as signal multipath can provide anomalous or inaccurate triangulation results. Examples of the invention have the advantage of providing location information without the need for GPS signals or relying upon triangulation.

In one possibility a memory stores associations between a location and an inactivity time interval to enable a shut-down controller vehicle to adjust the inactivity time interval based on location information of the vehicle. This has the advantage that the inactivity time interval can be adapted throughout the facility. Optionally location information may be reported from a vehicle to a central server.

In one possibility the server stores a plurality of associations between a plurality of vehicles and respective ones of a plurality locations. This enables the server to keep track of the number of vehicles in a given location of the warehouse and preferably to send a command to a shut down controller to set an inactivity time interval based on the number of vehicles in a location. Preferably this is also based on location so that the inactivity time interval can be set to a lower value in a parking area where many vehicles are present than in a working area of a facility.

As will be appreciated, features from any one aspect or example may be implemented in combination with all or some of the features of another aspect and features of any described embodiment may be employed in combination with all or some of the features of any other embodiment. Equally features described with reference to performance of a method also extend to (but do not require) specific hardware adapted to support that method.

### BRIEF SUMMARY

A vehicle power controller and a control method are described. The vehicle power controller is arranged to receive a remote command to set an inactivity time interval and to shut down a component of a vehicle, such as an engine, if it is inactive for the time interval.

One object of the present disclosure is to describe an improved vehicle power controller and control method.

### BRIEF DESCRIPTION OF THE SEVERAL VIEWS OF THE DRAWINGS

FIG. 1 depicts an authorisation control unit installed on a vehicle.

FIG. 2 depicts a driver access token coupled to a driver access token update system.

FIG. 3 depicts a warehouse facility having a facility access control and driver access token update system.

FIG. 4 depicts a schematic diagram of vehicle components and a CANBUS vehicle bus.

FIG. 5 shows a schematic representation of a warehouse with a facility control system.

FIG. 6 shows a schematic representation of a programmable vehicle power controller.

FIG. 7 is a schematic flow chart representation of operation of a vehicle power controller.

FIG. 8 is a schematic flow chart representation of a method of configuring a controller according to FIG. 6.

FIG. 9 shows a very schematic representation of a warehouse positioning system.

### DETAILED DESCRIPTION

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates.

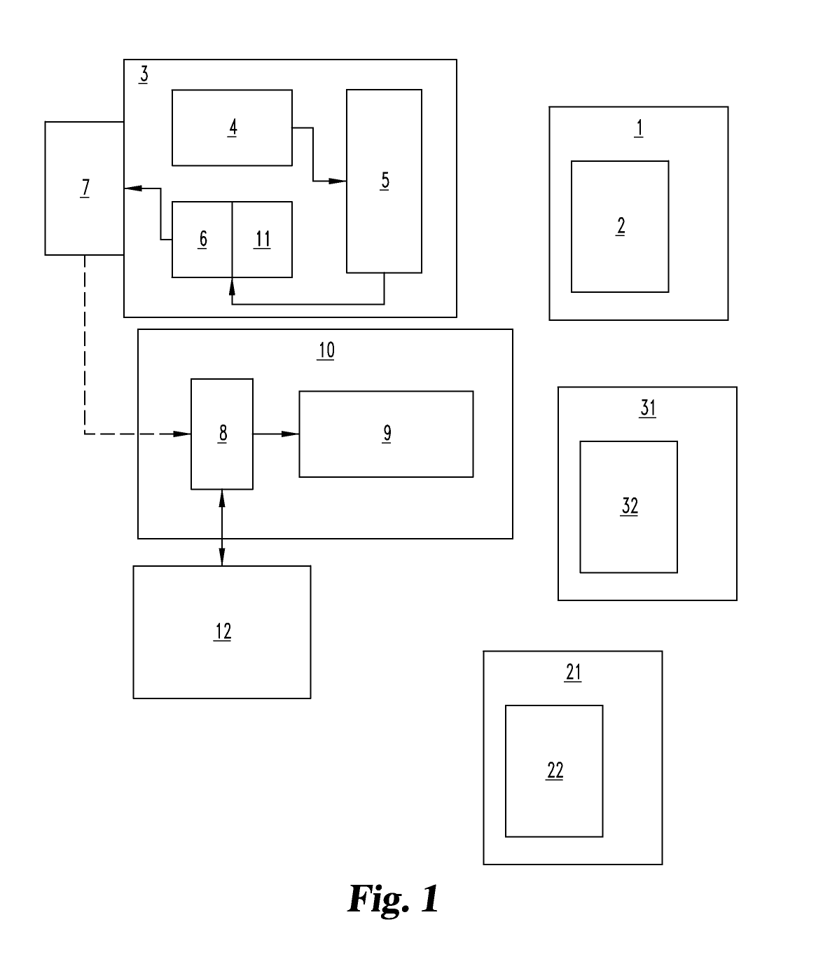

In the example of FIG. 1 an authorisation control unit 3 has vehicle identity logic 4 coupled to a near field RF communication interface 5. The near field RF communication interface 5 is coupled to driver record logic 6 and to enable logic 11 which in turn is coupled to a vehicle interface 7. When the authorisation control unit is mounted on a vehicle 10 the vehicle interface can be coupled to a secure enablement unit 8 coupled to control at least a part of vehicle functionality 21.

Vehicle 10 is a reach truck with an out rigging of telescoping forks that move up and down. The forks are suitable for lifting and manipulating pallets and also include hydraulics that allow the operator to pick up a load and reposition it over the outriggers and allow the forks to position pallets into shelving by sliding the pallet into place. Vehicle 10 is a stand-up reach model operable to slide forks under the pallet, transport it to the desired storage location, and slide it into place, typically these trucks are used for shelving units that are no deeper than required to place one pallet of goods. Optionally vehicle 10 may be a double deep reach or straddle reach truck that can not only slide under the pallet, but also grab the sides as well. Typically a facility such as a warehouse will make use of all these types of reach truck in addition to other types of materials handling vehicles and other vehicles which may have varying training or license requirements. The present invention is described with particular reference to such vehicles but, as will be appreciated these examples are provided by way of illustration and the invention is not so limited.

A removable rewritable driver token 1 has a memory 2 coupled to a near field RF communication interface for communicating with a near field RF communication interface of an authorisation control unit. Memory 2 stores a unique driver identifier and a list of vehicle identifiers to indicate vehicles the driver is authorised to operate.

The vehicle identity logic 4 includes a memory which stores at least one vehicle identifier and at least one vehicle enable code. Communication interface 5 is arranged to read vehicle identity information from the vehicle identity logic and to read information using near field RF communication from driver tokens 1 in near field range. Typically, in operation, when a communication interface 4 detects a token 1 in near field range it transmits an RF signal which couples inductively with an inductive coupling element of the driver token. Using electric power derived from the inductively coupled RF signal (or using an integrated power supply) the token communicates stored driver authorisation information back to the communication interface 5.

Driver authorisation information comprises a unique driver identifier code and a list of vehicle authorisation codes. As the communication interface reads the driver authorisation information it can communicate the unique driver identifier to the driver record logic. Listed vehicle identifiers are compared with vehicle identity information stored by the vehicle identifier logic. In the event that a listed vehicle identifier matches stored vehicle identity information the enable logic 11 generates an enable signal for the vehicle based on matching the vehicle identifier for the vehicle on which the authorisation control device is installed with one of the vehicle identifiers in the list of authorised vehicles stored in the token. The enable signal may be configured (e.g. coded) only to activate a particular vehicle to prevent unauthorised removal and transfer of authorisation units between vehicles. The driver record logic makes an entry in a non-volatile memory to record a vehicle authorisation and communicates an authorisation signal to the vehicle interface 7. Advantageously the authorisation system is self contained and no real-time communication to an outside system or database is required for authorisation. The device does not require complex logic to determine whether the driver is authorised; instead it simply needs to match its own vehicle identifier with the list stored on the driver token.

In the event that no listed vehicle identifier matches stored vehicle identity information the driver record logic makes an entry in memory to record a failed vehicle authorisation attempt. It is desirable for the authorisation control unit 3 to provide information to a user to indicate a successful or unsuccessful authorisation. Repeated unsuccessful authorisation attempts may trigger a lockout period during which no further authorisation attempts will be accepted. A user indication, typically a red light or low pitch tone may be provided to indicate this status to a user.

In one embodiment, during operation of the vehicle the communication interface communicates periodically or intermittently with the removable rewritable driver token 1 to ensure that the driver token has not been removed. In the event that, after operation of a vehicle has commenced, a secure driver access token is not detected by the communication interface an alert procedure is triggered by enable logic 11. Alternatively the vehicle may be activated for a predetermined period (e.g. a shift period, an interval between prescribed breaks) which may be configurable. An alert procedure may comprise initiating a visible and/or audible alarm signal, gradually reducing the vehicle speed if the vehicle is in motion until the vehicle become stationary, preventing the vehicle from moving if it is stationary, disabling at least one function of the vehicle, recording an event using an event logging buffer and communicating over a wireless communication interface with a remote device to call a supervisor or other authorised operator.

In another aspect there is provided an interface device for a vehicle having a control bus over which vehicle parameters are passed comprising a vehicle interface for communicating with a control bus of the vehicle; a wireless interface for communicating data packets with a remote server; buffer memory for storing packets to send over the wireless interface; and a processor for controlling communication, wherein the processor is arranged to detect whether wireless interface is available for live transmission to the server and to select information for transmission or buffering based on availability. In this way, the vehicle can operate robustly with an intermittent interface, contrary to some prior designs which go to great lengths to ensure a site will provide a reliable communication path. In the event the interface is unavailable, only higher priority data may be stored for subsequent transmission when the interface becomes available again.

An interface device typically will have a further memory for storing information separate from the buffer, wherein the processor is arranged to respond to a query received over the interface to transmit information stored in the further memory on request. The further memory may store detailed vehicle parameters and history and portions of it may be queried, either by reference to parameter labels or to memory addresses or both, or in response to a memory dump request. As in the previous embodiments, the parameters may be CANBUS parameters.

In some examples an operator communication interface arranged to store operator input received when the interface is not available for transmission at a time the wireless interface is available.

In this way, an operator (driver) may return information to base but need not be in direct communication at all times. The operator input may be active, for example an operator keying information into a terminal or keypad or passively collected, for example an operator presenting an authorisation token or taking an action may trigger an operator input signal without direct (other) intervention by the operator.

In some examples the wireless interface is a telecommunications interface having a data transmission protocol and a text message protocol wherein the apparatus is arranged to format data into messages suitable for transmission by the text message protocol in the event the data transmission protocol is unavailable.

Whereas a GPRS (or 3G) protocol is well known for GSM type modems, in some locations, it can be unreliable and less robust than an SMS protocol. According to this aspect of the invention, the interface may continue to operate (albeit at reduced data throughput) if only SMS communication is available. In conjunction with the prioritisation functions, a highly robust remote interface may be provided. In other applications, a Wifi 802.11 (b/g/n etc) communication link may be provided.

In one possibility the processor is arranged to communicate operator information bi-directionally with an operator console or operator application. Therefore, there is provided a server for communicating with a plurality of remote vehicles each having an interface device the server comprising vehicle data memory for storing vehicle information received from a plurality of vehicles and operator information memory for storing operator information received or messages for transmission to the operator. In some examples the server is arranged to make the vehicle data memory available to a first application and the operator information memory available to a second application.

In this way a maintenance application may access vehicle parameter records and may transmit queries for further remote diagnosis and a management or workflow planning or timekeeping application may communicate with the operator or make use of the operator data, over the same (robust) communication interface.

In the example of FIG. 1 enable logic 11 is configured to co-operate only with a particular vehicle having a particular secure enablement unit 8. Communication between enable logic and the secure enablement unit can be preceded by a secure handshake in which the enable logic provides the secure enablement unit 8 with a unique vehicle identifier and in the event that the unique vehicle identifier does not match a value stored in the secure enablement unit at least one operation of the vehicle is inhibited. Therefore if vehicle authorisation control unit 11 is swapped onto a different vehicle without authorisation (reprogramming of vehicle identity logic 4) then at least a part of vehicle functionality 10 will be disabled. In other embodiments, the vehicle identifier is read from the vehicle so the authorisation control unit can be swapped between vehicles without the need for reprogramming. In others the ID is stored programmably.

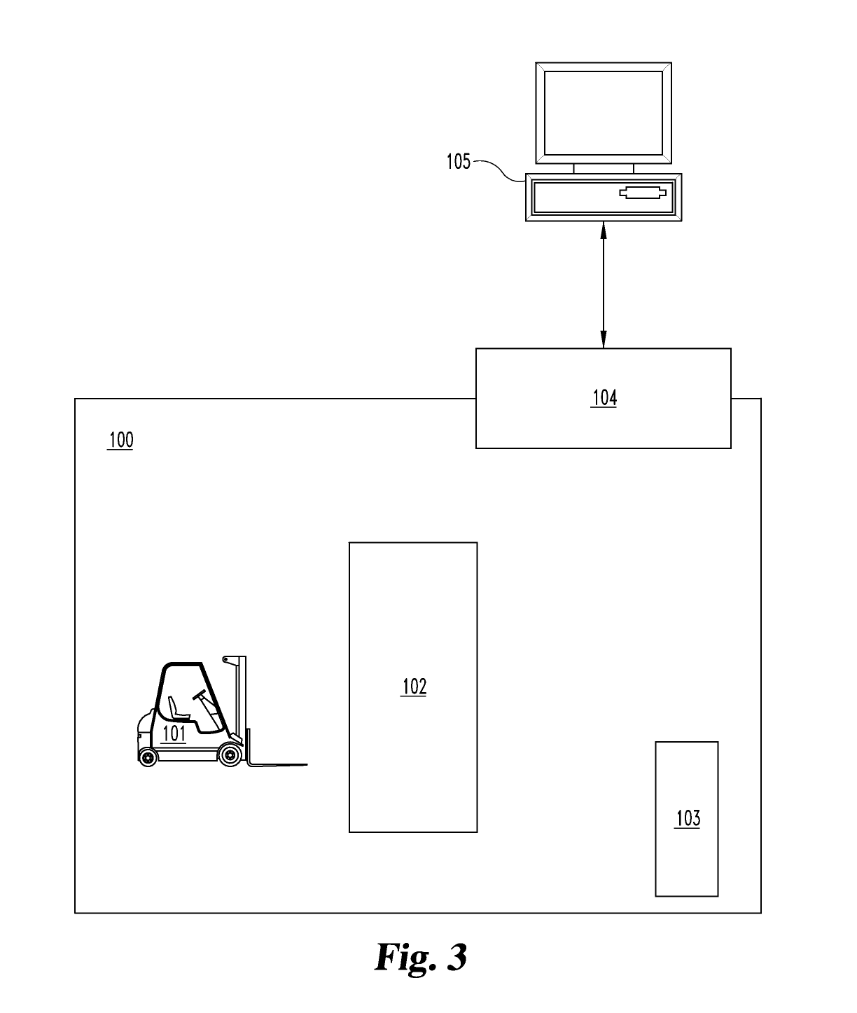

Driver record logic 6 comprises a non volatile memory and a read/write interface to permit data to be written to and read from the non volatile memory. Once an operator has been authorised to operate the vehicle the unique driver identifier is recorded and an event log, associated with that driver identifier is created and maintained. An event log typically includes time and date information, one or more event indications and particular operational parameters of the vehicle during operation by that driver. For example an event indication may be an accelerometer or tilt switch indication to provide a record that a vehicle has been tilted or has suffered an impact. Typically only events which exceed a threshold (for example a threshold acceleration/impact or a threshold tilt angle) are recorded, thereby the authorisation device is able to obtain and record a unique driver identifier or pass it on to other systems (e.g. remotely) for use for example in identifying an individual driver in the event of an incident. Incident reporting and monitoring is described below in greater detail with reference to FIG. 3.

Driver access token 1 comprises a memory 2 storing user interface information readable by vehicle authorisation control device 3. User interface information read from driver access token 1 is used to configure a user interface 12 of the vehicle. User interface 12 comprises controls 13 configurable by the user interface information to provide control of one or more operations of a vehicle. User interface information selectably configures controls 13 to control functions of vehicle 10 for example start and stop and in some embodiments may include directional movement controls, lift extent and reach of the truck. By controlling configuration of the user interface operating permissions of a user can be provided in a way that cannot be overridden by the user.

As described above, different vehicles have different capabilities and such vehicles may require different levels of training and/or authorisation in order to ensure safe and effective operation and to comply with regulatory standards, for example health and safety standards. In addition different users may be permitted to operate vehicles in different ways, for example certain users may be permitted only to operate vehicles carrying loads less than a selected limit and or to operate vehicles below a restricted speed or not to extend the manipulation arms (forks or straddle reach) of the vehicle beyond a given height or extent.

User interface information can configure controls 13 to provide operator access to selected features. For example a user who is a technician or vehicle engineer can be provided with an access token 1 configured with a technician attribute. On presenting such a token the technician is presented with user interface information to provide access to some or all of the diagnostic and/or maintenance functions of a vehicle. Normally there will be a limited number of “superusers” such as a supervisor or a technician. A supervisor has a supervisor attribute set (for example a binary identifier associated with the token) which may authorise the supervisor to drive any vehicle without requiring a vehicle identifier match and/or enable the supervisor to reset alarms or enable a vehicle after an incident in which operation of the vehicle has been disabled by the authorisation control unit. Certain vehicles may be more technically complex than others or require different maintenance training It is possible that certain maintenance tasks may require a technician attribute and/or a vehicle identifier match. Without a vehicle identifier match a technician may be authorised only to disable a vehicle to prevent use of the vehicle before maintenance is complete and to operate certain diagnostic functions of the vehicle. A technician with a vehicle identifier match may be authorised to carry out the full range of diagnostic and maintenance functions. As noted a user who is a supervisor may be authorised to operate all functions of a vehicle and to override certain time lock-out and alarm functions. As will be appreciated in the context of the particular examples provided, other examples of specific attributes giving “special” permissions based on user interface information may be employed. Example user interfaces include sets of buttons with corresponding visual indicators to indicate the function each button is configured to provide, alternatively or additionally a user interface includes a touch sensitive screen upon which a set or sets of menus and configurable soft keys can be provided to provide configurable user controls 13.

Information for configuring the user interface may be stored on the driver access token 1 and/or stored on the authorisation control device 3 and activated dependent on information stored on the token. Authorisation control unit 3 uses a high performance 16 bit microcontroller to run a configurable application to manage and report on the vehicle operators. The activity of the operator is logged for reporting to a control room. Typically communication interface 5 uses a MIFARE™ contact-less RFID card to store the user profile and access rights. Authorisation control unit 3 can be powered from an automotive power source (12 or 24V) and ideally is tested to ISO 7637 standards.

As described in more detail above, different operating modes can be selected and authorisation control unit 3 can shutdown the equipment in the event of an impact or excess idling. To provide this and additional functions a secure authorisation and control unit can be coupled to a vehicle control system such as a CANBUS to allow microcontrollers and devices to communicate with each other within vehicle 10 without a host computer. Preferably monitoring and control data read from the CANBUS is communicated to a remote device via the authorisation control device. Communicated information can include for example: service hours; current, minimum and maximum engine speed (rpm); current, minimum and maximum oil pressure; current, minimum and maximum water temperature; and other diagnostic parameters. Odometer information may also be provided including vehicle idle time, vehicle speed, fuel economy (instantaneous and running average values). In preferable embodiments a second CANBUS interface is provided.

Other parameters which may be usefully monitored include all basic instrumentation information, the machine serial number, traction and hydraulic hour meters, speed and battery voltage, motor and pump temperatures and fault codes. In one embodiment the power requirements of an authorisation control device are less than 5 Watts and the device may be operable over a voltage range of between 6 and 30 Volts DC.

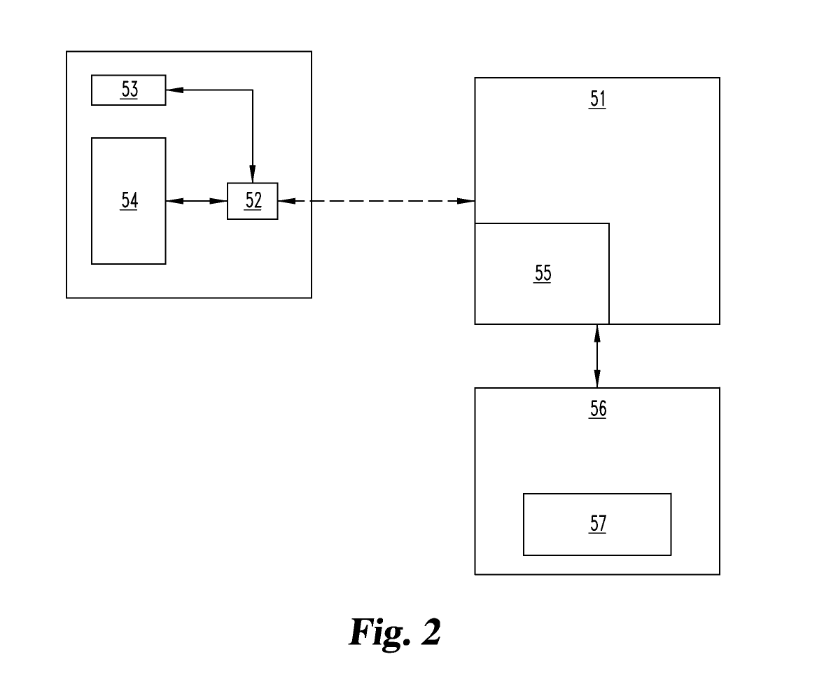

The example of FIG. 2 shows a driver access token 50 coupled to a driver access token update system 51. Removable rewritable driver token 50 has a communication interface 52 coupled to read and write data to a memory storing a unique driver identifier 53 and to read and write data to a memory storing a list of a plurality of authorised vehicle identifiers 54.

Driver access token update system 51 comprises a communication interface 55 for communicating with communication interface 52 of a driver access token. Update system 51 is coupled to a controller 56. Controller 56 typically provides processor functionality comparable to a personal computer and operates using facility access software 57.

The token 50 is couplable to the update system 51 via communication interfaces 52 and 55 to communicate (i.e. read and write) data between memory held on the token and the update system. The token 50 is marked with visible text and/or a photo ID and may also store data for use by a facility access control and monitoring application for monitoring time and attendance and/or providing secured access to a building.

Driver access token update system 51 comprises an access point to which a driver may present a token, for example on “clocking on” for work and gaining access to the facility in which he is to work. The access point includes reader circuitry for reading the token to recognise a unique identifier of the token and writing logic for updating the list of authorised vehicles stored on the token. Each time a driver presents the token to an access point to gain access to the facility, the list of vehicles he is authorised to may be updated at that time. In this way no complex communication between a central controller and vehicles within the facility is required and a simple list of vehicle authorisations can be written to access card memory by taking advantage of a routine daily process and without the operator or supervisor needing to perform any additional tasks. To support this function a software platform is provided which contains a list of vehicle access permissions for each operator and one or more pieces of user interface information. This application maintains a list of functions an operator is permitted to use in the control, and/or maintenance and repair of vehicles and interfaces with infrastructure in a facility (such as a warehouse) to manage

A warehouse facility is illustrated in schematic form in FIG. 3 in which a warehouse facility 100 houses a mobile asset 101, a plurality of moveable stationary assets 102 and a wireless communication relay 103. Access to the facility is controlled by management system 104 (which includes features of the driver access token update system 51 described above with reference to FIG. 2). Management system 104 is in communication with user interface and control means 105.

Mobile asset 101 is configured to communicate wirelessly with management system 104 via communication relay 103. Mobile asset 101 carries an authorisation control device 3 as (described above with reference to FIG. 1) which stores information for communication with management system 104. Stored information is stored in a buffer local to the authorisation control device 3 and is communicated to the communication relay when a clear communication channel is available. Thereby, in the event that mobile asset 101 moves moveable stationary assets 102 in such a way that modifies the wireless communication environment or is simply out of radio contact, no immediate problem results as information is stored and can be transmitted when communication is re-established. This addresses the disadvantages of some prior art systems in which real-time information is required to be sent directly to a management system and provides a robust communication and management method in an unpredictable radio environment.

In an example event information is stored locally and only transmitted if impact or tilt information associated with an event exceeds a threshold as described above. This further improves the robustness of the system by reducing bandwidth demands on the communication. In addition, when an event is detected a technician or supervisor can review a comprehensive record of the vehicles operation without the need to transmit large volumes of information over a wireless link.

Management system 104 and/or user interface and control means 105 is configurable with software to report stock volumes and operator attendance information for stock monitoring and control. The software can be provided with an interface for modifying per vehicle permissions of an operator based on information held in other applications or systems, for example in personnel records. Advantageously sensitive asset control permissions can be controlled with reference to centrally held and verified personnel records, for example training certificates and other information.

Updates may be processed at separate times and simply updated at next presenting of the token. In one example a driver token may be provided as part of an ignition key or a key fob.

In some embodiments or aspects the invention provides methods of updating the memory of the token by providing an incremental update of the token memory, for example by overwriting a single memory entry, groups of memory entries or overwriting the entire memory. Similarly embodiments or aspects may provide methods of querying the memory of the token by providing a stepwise (sequential) query of the token memory, for example by reading a single memory entry, reading groups of memory entries or reading the entire memory.

To determine whether an operator is authorised for a particular vehicle communication interface 5 reads a list of a plurality of vehicle identifiers from a non volatile memory of a secure access token 1. Each vehicle identifier is compared with at least one stored vehicle identity attribute derived from the vehicle identifier logic.

Enable logic 8 (FIG. 1) can be configured to provide an authorisation signal based on a match between a vehicle identifier stored on a secure access token 1, 50 (FIGS. 1 and 2) without looking up a driver identifier. As described above, in a warehouse facility the secure authorisation unit 3 will typically have only an intermittent communication link to management system 104 105. Secure authorisation unit 3 (FIG. 1) permits an authorisation to be given without requiring a response from central computer in response to presenting a token programmed with correct permissions. To provide enhanced security and control functions while permitting flexible operation the secure authorisation unit is arranged to authorise vehicle in response to a match and to buffer driver ID and communicate it to central computer when a communication link become available, for example when a link with communication relay 103 provides at least a threshold quality of service or error rate.

In environments where the available communications bandwidth is limited, or to provide improved battery performance the authorisation control device 3 is arranged to communicate driver identification information following an incident or an event such as a detected impact. To provide similar advantages authorisation control device 3 is arranged to communicate driver identification information in response to a command received over a second communication interface and/or from central computer. When an event or incident such as an impact is detected at least part of vehicle functionality 9 may be disabled and require a reset authority before permitting the vehicle operation to continue.

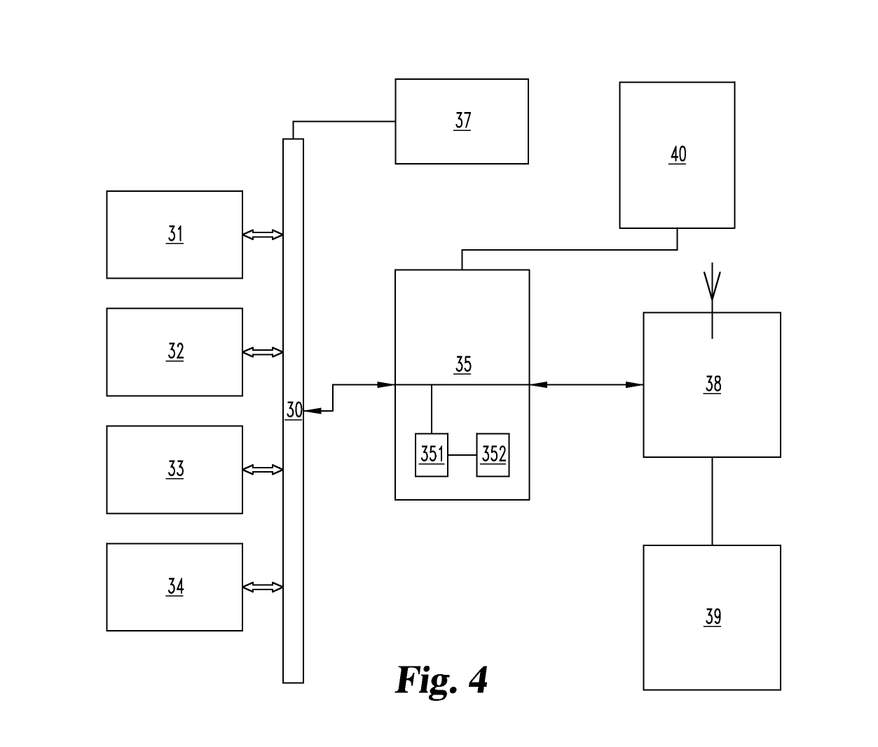

In FIG. 4 a schematic diagram of vehicle components includes a CANBUS vehicle bus 30 to allow microcontrollers and vehicle systems to communicate with each other, for control and monitoring functions within the vehicle. The CANBUS 30 is arranged for communication between hydraulic system 31, engine 32, speed and directional control systems 33 and battery control system 34 and other vehicle systems (not shown).

A control unit 35, such as an authorisation control unit, is coupled to a non volatile memory 40 and is arranged to read information from the CANBUS 30. Typically, control unit 35 comprises logic 351 coupled to a memory 352 storing programmable reporting thresholds (minimum or maximum levels) and/or ranges. An event indicator 36 is coupled to the control unit 35. FIFO CANBUS buffer is coupled to the CANBUS 30 and to control unit 35. A vehicle communications interface 38 is provided with communications buffer 39.

FIFO CANBUS buffer 37 provides a first-in-first-out buffer memory to record the status of the CANBUS over a period of time. Control unit 35 is configured to read the contents of the FIFO CANBUS buffer 37 into non volatile memory 40 in the event that event indicator 36 indicates that an event is detected. Control unit 35 may poll the event indicator periodically (or in round-robin fashion if more than one event indicator is present) or may be arranged to receive an interrupt signal transmitted by event indicator 36 to trigger the contents of the FIFO CANBUS buffer 37 to be dumped into non volatile memory 40.

Generally, to avoid clashes on the CANBUS, the FIFO CANBUS buffer is coupled to the CANBUS as a receive-only node (i.e. it does not transmit any messages on the BUS). As will be appreciated in the context of the present application, each node is typically able to send and receive messages, but not simultaneously. Generally a message includes an identifier to indicate the message-type and/or sender—and up to eight message bytes. Messages are transmitted serially onto the bus, one bit after another. The FIFO buffer is programmable to monitor CANBUS traffic relating only to particular devices or vehicle systems by filtering using the CANBUS identifier. To increase the period of time over which CANBUS data may be recorded by the FIFO buffer the FIFO buffer preferably is programmable via selection parameters to buffer only a subset of transmitted CANBUS information (i.e. CANBUS messages having particular device identifiers and/or message type). The selection parameters for this CANBUS message filter may be configured remotely, for example by a diagnostic engineer at a remote terminal in communication with the vehicle.

The use of a CANBUS buffer enables the state of the CANBUS before any given event to be known, it is not required to record all CANBUS information and it is not required to transmit CANBUS information in real time. In response to particular CANBUS events (CAN parameters exceeding certain programmable thresholds or ranges) or other events the contents of the buffer can be transmitted and/or dumped into a local non-volatile memory (such as a hard disk or flash memory). This enables the occurrence of events to be monitored without the need for real-time communication which is costly in terms of bandwidth

Information available for reading from the CANBUS 30 includes hydraulic pressure, oil pressure and temperature, lift time, move time, vehicle speed, brake operation, brake fluid levels and pressures, coolant temperature, battery charge levels and other vehicle information. As will be appreciated by the skilled practitioner the foregoing list is illustrative only and in any particular case fewer or more parameters may be available to be read from the CANBUS.

During usual operation of the vehicle control logic 30 is arranged to read information from the CANBUS and to compare information with one or more programmable reporting thresholds or ranges. A threshold or range may be programmed for any or all information which is available to be read from the CANBUS.

On the basis of a comparison between CANBUS information and one or more thresholds and/or ranges (as described above) control unit logic 351 may determine to report and/or record current CANBUS information using communication interface 38. Communications buffer 39 provides local storage of communication information. Buffered communication information can be transmitted directly, buffered temporarily before transmission, stored in non-volatile memory 40 and transmitted subsequently, for example in the event that the communication buffer 40 overflows. This technique enables transmission to take place when transmission conditions are favourable or when a request is transmitted by a facility control station. By this method the need for real time communication can be entirely avoided thereby increasing transmitter battery life, reducing bandwidth requirements (for example by transmitting information when higher bandwidth is available) and enabling vehicle operation and diagnostic information to be monitored in a manner that is robust and reliable.

Communications interface 38 may be a discrete unit or it may be integrated into other vehicle functionality or provided by or included in an authorisation control unit substantially as described herein with reference to FIG. 3.

An event indicator 36 may include an alarm button, an accelerometer, a tilt switch, a gyroscope and/or a location determiner (such as GPS or a robust local location determining system such as the RFID grid described herein below)

Asset performance monitoring is performed based on CANBUS information and other event indicators collected in each asset using the systems described. Associated with each vehicle is a performance score which is calculated based on vehicle parameters. Systems in a vehicle may be subdivided between critical systems and performance support systems. For example an asset may still operate safely and effectively, albeit sub-optimally with a lower than ideal tire pressure or slightly reduced oil levels or hydraulic pressure. Such parameters are referred to herein as non-critical parameters (i.e. those not mandated by safety requirements or operating needs of an asset) and may be given integer values between 1 and 100 to indicate a percentage score. Certain other parameters, for example oil temperature, fuel level, battery level and coolant levels may be considered critical parameters. In other words, if these values are not within a given range safe and/or effective functioning of the vehicle is prevented. Within certain ranges critical parameters may be considered non critical and may be assigned a score which contributes to the overall performance score of the vehicle. An overall performance score can be assigned for example as P, where

$$P = {\prod }_{i = 1}^{N} {X}_{i} {\sum }_{j = 1}^{M} {Y}_{j} \qquad ( 1 )$$

In equation 1 above Xᵢ indicate critical parameters, which are binary indicators. If any critical parameter is zero the overall system score is zero and the asset is considered non-functioning. Each term Yⱼ indicates a score associated with a non-critical parameter, as will be appreciated certain parameters which are critical parameters outside certain ranges may be considered critical if they go beyond permitted ranges. Therefore the same vehicle system may contribute to the overall performance score P as both a critical and non critical parameter. Other methods of calculating a performance score will be apparent to the skilled practitioner in the context of the present application and any appropriate method may be chosen dependent on the particular constraints of a given situation. Whatever performance scoring system is used each vehicle is associated with an indication which can be used to assess when (i.e. how soon) maintenance actions may be required or for how long such actions can be postponed. Preferably the indication is accompanied by at least some diagnostic reporting information such as selected CANBUS information, impact or tilt indications and/or fault codes.

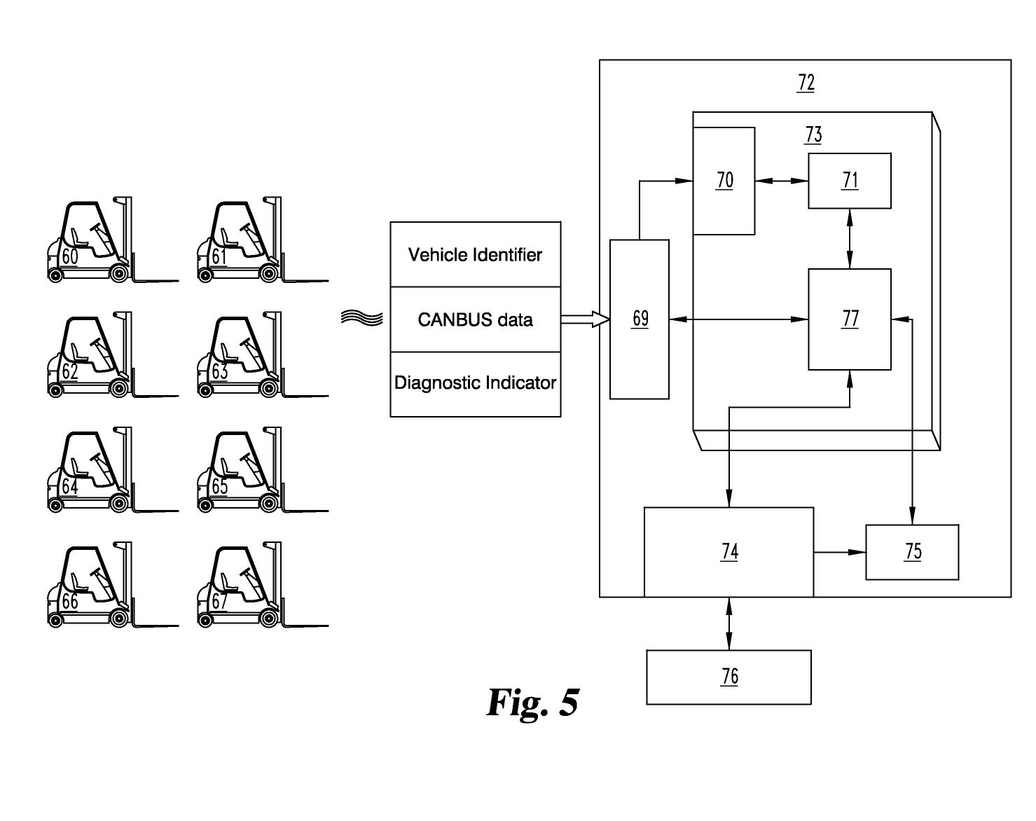

The diagram of FIG. 5 shows a plurality of mobile assets 60, 61, 62, 63, 64, 65, 66, 67, 68 each of which comprise a communication interface for wireless communication 69 with a local communication interface of a facility control system 72. The facility control system comprises a controller 73 coupled to communicate with one or more of the mobile assets via local communication interface 69 and to communicate with remote station 76 via wide area communication interface 76. The facility control system 72 comprises a non-volatile memory 75 coupled to controller 73. Controller 73 comprises control logic 77, vehicle diagnostics logic 70 and correlator 71. Controller 73 is arranged to communicate with local communication interface 69 to monitor received vehicle information (for example vehicle information transmitted by a system substantially as described with reference to FIG. 4) and to transmit vehicle control and information messages via wireless communication 68.

A first vehicle 63 is arranged to communicate vehicle information with local area communication interface 69, the vehicle information comprising vehicle identifier information, CANBUS data and a diagnostic or event indicator such as a fault code. Based on CANBUS data, diagnostic or event indicator information a performance score can be calculated for each vehicle. Dependent on the particular constraints of each application the performance score may be calculated in each vehicle and transmitted to facility control system 72 or required information can be collated centrally so that a score can be assigned. Alternatively a mixture of these two approaches can be employed.

In general operation a vehicle will communicate information with the facility control system on a periodic or intermittent basis so that the vehicle status can be tracked. Real-time information is not communicated to avoid placing an undue burden on the communications network. Periodic or intermittent updates can be sent or event driven updates may be or buffered/recorded as described above in response to performance score changes or other events.

Correlator 71 maintains a table of vehicle status information comprising a plurality of vehicle status entries including performance scores. In this example each vehicle status entry is determined by vehicle diagnostics logic 70. Vehicle diagnostics logic and correlator 71 co-operate to determine a likely maintenance schedule for each vehicle based on at least one of a performance score or a performance indicator.

Vehicle components may have a finite predictable life which depends, inter alia, on factors including mileage, engine RPM, oil pressure and temperature and other engine parameters. Where appropriate the time integral and/or the average of these parameters may be used to predict the lifetime of components by reference to manufacturer's data sheets or historical data obtained from asset locations.

On the basis of a diagnostic indicator or an event indicator control logic 77 determines whether the received information relates to a routine maintenance status update or to an event indication.

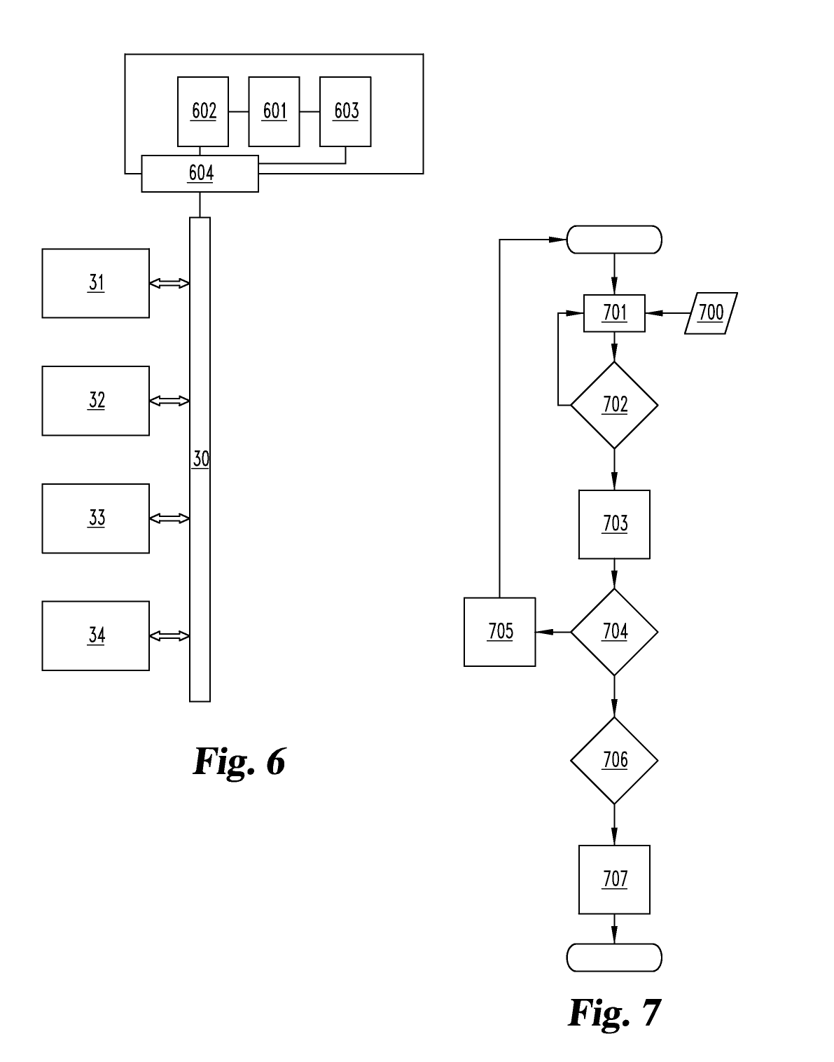

In the example of FIG. 6 an diagram of a programmable vehicle power controller is shown comprising a timer 601 and a vehicle idling sensor 602 coupled to the timer and to the CANBUS 30 of the vehicle (not shown) to sense whether the vehicle is idling. CANBUS 30 is coupled to communicate CANBUS messages with a plurality of vehicle systems 31, 32, 33, 34.

A switch arrangement (shutdown controller) 603 is coupled to the timer 601 and is arranged to shut down a power supply in the vehicle in response to the timer indicating that a time interval has elapsed. The vehicle power controller 600 is provided with a communication interface 604 to receive commands and/or other information. The programmable vehicle power controller 600 is programmable to set the time interval based on one or more received commands and/or other information, such as CANBUS messages.

For connection to the CANBUS, communication interface 604 comprises a host-processor to parse received messages to determine their type ID and their content and to transmit messages on to the CANBUS. Further sensors, actuators and other control devices can be connected to the host-processor. The communication interface further comprises a synchronous clock to control the rate at which, the interface 604 reads bits (one by one) from the bus. Messages for transmission onto the BUS are stored by the host-processor and the bits transmitted serially onto the bus. As will be appreciated, signal level regulation and other adapters are applied to provide suitable voltage transmission onto the BUS and to protect electronics from overvoltage conditions. On a BUS of a length typically found in a vehicle (20 metres or less) bit rates up to of up to 1 Mbit/s are provided. The CANBUS protocol standard is described in greater detail in ISO 11898-1 (2003) the entirety of which is incorporated herein by reference.

In FIG. 6 the switch arrangement 603 is provided by an interface to the CANBUS operable to send an “engine off' message to the ignition system or other power control system of the engine. In this example the communication interface 604 includes the CANBUS interface and can further include a wireless communication system such as a wifi interface, GSM GPRS, UMTS or other wireless interface.

The flow chart of FIG. 7 provides a schematic representation of operation of a vehicle power controller in which an idling indicator 700 is received by the controller at 701 which determines 702 whether the engine is idling. In the event that the engine is idle the timer is started 703. If, at 704, it is determined that the engine has ceased to be idle then the timer is reset 705. In the event that the engine remains idle until the time limit is determined at 706 to have expired a control signal is provided, for example using switch arrangement 603, to switch off the engine.

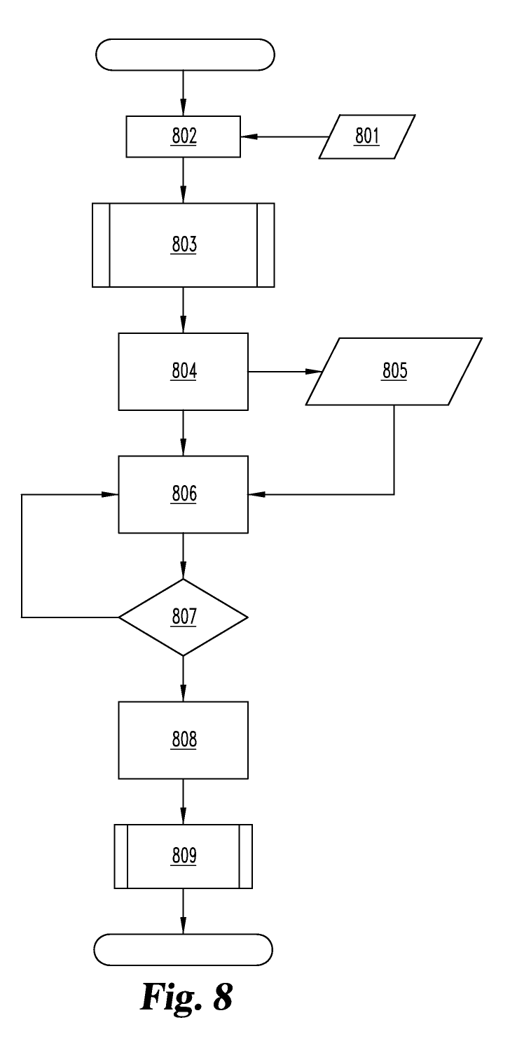

The flow chart of FIG. 8 shows a representation of a method of configuring the time interval such as for use in a controller according to FIG. 6. A command 801 provides configuration information which is received at 802 and processed at 803 to determine criteria for modification of the time interval dependent on CANBUS message information. In response to the process output, based on the received command the vehicle power controller is configured at 804 to monitor the CANBUS for CANBUS messages associated with a particular vehicle system (for example having a particular type identifier 805) such as a fuel gauge reading and/or a battery level reading. One or more CANBUS message type identifiers are written into a memory and, at 806 messages associated with that CANBUS message identifier are read from the CANBUS to derive device information associated with that type identifier. In the event that a message of the identified type is received the message is parsed and, in the event that it is determined that the time interval needs to be updated the timer is updated accordingly and monitoring of idle time is then performed according to the process described above with reference to FIG. 7.

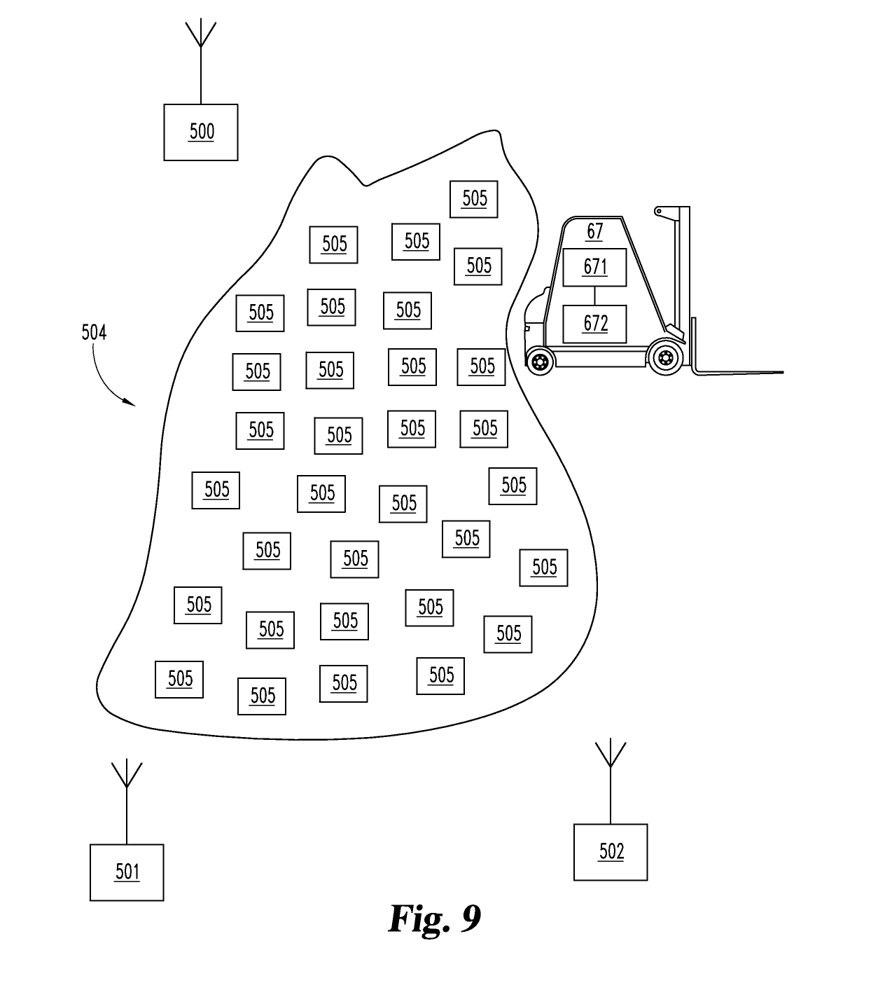

FIG. 9 shows a facility 504 in which a plurality of passive RFID tags 505 is distributed at fixed locations. Disposed about the facility, at known reference locations are at least three reference communicators 500, 501, 502. A mobile device 67 in wireless communication with reference communicators comprises an RFID reader for reading the plurality of RFID tags and a memory 671 coupled to the reader.

In a calibration step the mobile asset traverses the facility 504 while triangulating its position between the at least three reference communicators 500, 501, 502 via wireless communication. As the facility is traversed each RFID tag is read and the tag data is stored in the memory 671 along with triangulated position information. Thereby a stored association is created between each tag (or each of a plurality of sets of tags) and triangulated location information. Clearly, triangulation is not required, GPS information could be used for this triangulation step. In certain facilities (for example underground facilities or facilities with heavy/dense/radio opaque superstructures) GPS signals are not available or are of insufficient quality to provide sufficiently accurate location information.

Logic functions and determining and aggregation steps described herein may be implemented by programming computing apparatus, for example a personal computer. Typically computing apparatus has a processor associated with memory (ROM and/or RAM), a mass storage device such as a hard disk drive, a removable medium drive (RMD) for receiving a removable medium (RM) such as a floppy disk, CDROM, DVD or the like, input and output (I/O) control units for interfacing with the components of the monitoring facility of FIG. 5 to enable the processor to control operation of these components. The user interface consists, for example, of a keyboard, a pointing device, a display such as a CRT or LCD display and a printer. The computing apparatus may also include a communications interface such as a modem or network card that enables the computing apparatus to communicate with other computing apparatus over a network such as a local area network (LAN), wide area network (WAN), an Intranet or the Internet. The processor may be programmed to provide the logic features of the examples described herein by any one or more of the following ways: 1) by pre-installing program instructions and any associated data in a non-volatile portion of the memory or on the mass storage device; 2) by downloading program instructions and any associated data from a removable medium received within the removable medium drive; 3) by downloading program instructions and any associated data as a signal supplied from another computing apparatus via the communications interface; and 4) by user input via the user interface.

The features of methods and devices set out herein relate to systems which can be used in conjunction with one another and are intended to be so combined where appropriate. It will be apparent that the features of any example, aspect or embodiment described herein may be combined with some or all of the features of any other embodiment aspect or example. In addition certain terminology used throughout the description should not be construed as limiting, for example where reference is made to a vehicle or a truck this may be any mobile asset having the required features and functionality. Equivalently sensors and detectors may be referred to interchangeably as indicated by the context of the description. It is apparent that many modifications and variations of the present invention are possible in light of the above teachings. References to specific values or standards are by way of example only. It is therefore to be understood that, within the scope of the appended claims the invention may be practised otherwise than as specifically described.

While the preferred embodiment of the invention has been illustrated and described in the drawings and foregoing description, the same is to be considered as illustrative and not restrictive in character, it being understood that all changes and modifications that come within the spirit of the invention are desired to be protected.

1. A programmable vehicle power controller comprising a wireless communication interface, and a vehicle inactivity detector for detecting inactivity affecting a component of a vehicle and a shutdown controller coupled to shut down at least the component of the vehicle, wherein the shutdown controller is arranged to receive over the wireless communication interface a command to set an inactivity time interval based on the received command and to shut down the component following inactivity for the time interval.

2. A programmable vehicle power controller according to claim 1 wherein the shutdown controller is further configured to shut down the vehicle in response to a received shut down command.

3. A programmable vehicle power controller according to claim 1 wherein the vehicle inactivity detector is coupled to a CANBUS of the vehicle to detect inactivity of a vehicle component.

4. A programmable vehicle power controller according to claim 3 wherein the component is an engine of the vehicle.

5. A programmable vehicle power controller according to claim 1 arranged to set an inactivity time interval based on a received command and vehicle operator information.

6. A programmable vehicle power controller according to claim 5, configured to derive vehicle operator information from an authorisation control unit arranged to record an identifier of a vehicle operator.

7. A programmable vehicle power controller according to claim 6 wherein vehicle operator information is derived from a removable reprogrammable token adapted for use with the authorisation control unit.

8. A programmable vehicle power controller according to claim 6 wherein the vehicle power controller is configured to set the time interval based on a time of day and vehicle operator information.

9. A programmable vehicle power controller according to claim 8 coupled to communicate with a database storing an association between vehicle operator information and an indication of shift timings of the operator, wherein the programmable vehicle power controller is configured to determine a time of day and to select an inactivity time interval based on the shift timings of the operator and the time of day, wherein at least one of: the database is stored in a memory carried on the vehicle; and the programmable vehicle power controller is arranged to communicate wirelessly with the database.

10. A programmable vehicle power controller according to claim 9 wherein the indication of shift timings comprise an indication of first and second periods and wherein the controller is arranged to select a first inactivity time interval during the first period and to select a second inactivity time interval during the second period, wherein the first period is associated with an operator's working shift.

11. A programmable vehicle power controller according to claim 1 having a position determining system for determining the location of a vehicle in a facility.

12. A programmable vehicle power controller according to claim 11, the position determining system comprising: a memory storing an association between one or more positions in the facility and a plurality of machine readable identifiers positioned about the facility; and a proximity reader for reading a machine readable identifier of the plurality of machine readable identifiers in a reading range of the reader; and
a processor, in communication with the reader wherein the processor is arranged to determine a position of the mobile asset based on the stored association.

13. A programmable vehicle power controller according to claim 12 wherein the mobile asset comprises logic for comparing an identifier with a stored association to determine a position of the mobile asset based on the stored association.

14. A programmable vehicle power controller according to claim 12 wherein the machine readable identifiers are positioned with a separation of at least five times the reading range of the reader.

15. A programmable vehicle power controller according to claim 11 in communication with a memory storing an association between a location of the facility and a stored inactivity time interval and configured to set the inactivity time interval based on the location of the vehicle in the facility.

16. A materials handling vehicle comprising a programmable vehicle power controller according to claim 1.

17. A facility monitoring and control system comprising a server having a wireless communication interface configured to communicate with a plurality of vehicle controllers to receive vehicle information; a database storing at least one association between vehicle information and an inactivity time interval; and a processor coupled to the communication interface and configured to retrieve a time interval from the database based on received vehicle information and to transmit a command comprising the inactivity time interval over the communication interface to a vehicle controller of the plurality of vehicle power controllers.

18. A facility monitoring and control system according to claim 17 in which the database stores an association between a plurality of vehicles and a single inactivity time interval and wherein the processor is configured to transmit a remote command comprising the single inactivity time interval to the plurality of vehicles.

19. A facility comprising a plurality of materials handling vehicles according to claim 16 and a facility monitoring and control system comprising a server having a wireless communication interface configured to communicate with a plurality of vehicle controllers to receive vehicle information; a database storing at least one association between vehicle information and an inactivity time interval; and a processor coupled to the communication interface and configured to retrieve a time interval from the database based on received vehicle information and to transmit a command comprising the inactivity time interval over the communication interface to a vehicle controller of the plurality of vehicle power controllers.

20. The facility of claim 19 comprising a plurality of machine readable markers each marker associated with a location; and one or more warehouse vehicles comprising a proximity reader for reading the machine readable markers; and comparison logic for comparing information read from the markers with a stored association to determine a location of the vehicle.
